(19) United States
(12) Patent Application Publication
(10) Pub. No.: US 2007/0048115 A1
(43) Pub. Date: Mar. 1, 2007

(54) Load carrying vehicle and ejection mechanism and methods related thereto

(76) Inventors: Nicholas Fenelli, Trenton, NJ (US); Robert A. Mullowney, Hartboro, PA (US)

Correspondence Address: HALL, MYERS, VANDE SANDE & PEQUIGNOT, LLP, 10220 RIVER ROAD, SUITE 200, POTOMAC, MD, 20854, US

(21) Appl. No.: 11/294,337

(22) Filed: Dec. 6, 2005

Related U.S. Application Data
(60) Provisional application No. 60/633,704, filed on Dec. 6, 2004.

(51) Int. Cl. B65F 3/00

(52) U.S. Cl. 414/512

(57) ABSTRACT

Apparatus for transporting, loading, and off-loading munitions with improved efficiency and safety. In preferred embodiments, a munitions transport and loading apparatus which employs omni-directional wheel modules for optimized maneuverability.

### RELATED APPLICATION DATA

This application claims the benefit of priority of U.S. Provisional Application No. 60/633,704, similarly titled, filed Dec. 6, 2004, the entirety of which is hereby incorporated by reference. The following additional documents, in their entireties, are hereby additionally incorporated by reference: U.S. Pat. No. 6,394,203, filed Dec. 6, 2001, issued to Donald Barnett Harris, entitled METHOD FOR DESIGNING LOW-VIBRATION OMNI-DIRECTIONAL WHEELS; U.S. Pat. No. 6,340,065, filed Jan. 22, 2002, issued to Donald Barnett Harris, entitled LOW VIBRATION OMNI-DIRECTIONAL WHEEL; U.S. Pat. No. 6,547,340, filed Dec. 6, 2001, issued to Donald Barnett Harris, entitled LOW VIBRATION OMNI-DIRECTION WHEEL; U.S. Pat. No. 6,796,618, filed Oct. 18, 2002, issued to Donald Barnett Harris, entitled METHOD FOR DESIGNING LOW VIBRATION OMNI-DIRECTIONAL WHEELS; and U.S. patent application Ser. No. 10/647,122, filed Aug. 25, 2003, applied for by Nicholas Fenelli et al., entitled RELOCATABLE OPERATOR STATION.

### FIELD OF INVENTION

This invention relates to an apparatus for transporting, loading, and off-loading munitions with improved efficiency and safety. In preferred embodiments, this invention relates to an apparatus which employs omni-directional wheel modules for optimizing maneuverability thereof.

### BACKGROUND OF INVENTION

Heretofore, various munitions handling equipment has been developed for loading and unloading munitions, armaments, and other payloads onto and off of aircraft. Such systems conventionally comprise a trailer-type apparatus that is towable behind a truck or tractor and/or can also be hand-trucked.

In a typical transport and loading operation, a munition is first loaded onto the carrier platform of the apparatus, and then the munitions carrier apparatus is transported to an aircraft (e.g. on an aircraft carrier) either via manpower or by towing with a motorized vehicle. Thereafter, the apparatus is manually positioned so that the munition can be elevated into an aircraft loading position (so that the munition can be mounted to the aircraft).

Although, over the years, prior art munitions handling equipment has been used with varying degrees of success for transporting, loading, and unloading munitions cargo, there are various unresolved drawbacks in the art related to the maneuverability of conventional munitions handling vehicles as well as their mechanisms for disposing of or offloading “hot” munitions. For example, prior art military munitions handling protocols for aircraft carriers necessitate extensive resource waste as well as high costs related to munitions handling. In this regard, employing current military protocols, once a “hot” munition is identified, rather than simply removing the munition from the munitions carrier vehicle, current aircraft carrier guidelines call for disposing the munition and the carrier vehicle by pushing the vehicle overboard e.g. into the ocean.

In this regard, modern Navy aircraft carriers are equipped with disposal ramps via which conventional munitions carrying vehicles and their munitions are disposed of into the ocean. Specifically such ramps have a disposal opening near the perimeter of the deck of the ship having a ramp which extends downwardly and tapers or narrows into a “throat” area having a uniform width. The throat passage, in turn, opens to the surrounding water body.

In order to dispose of a munition, then, the vehicle carrying the unwanted munition is simply pushed to the disposal ramp and down through the disposal opening. As the vehicle dimensions are smaller than the narrowest part of the disposal ramp, the entire munitions vehicle, including its cargo, falls to the ocean surface. As can be seen, therefore, each time a munition is disposed of, the munitions carrying vehicle must be replaced. This results in high use costs, requires that significant vehicle inventory and thus storage space be available, and results in wasted resources and/or unnecessary pollution. However, until now, other mechanisms or methods of disposing munitions have been unsafe or otherwise unsatisfactory.

In addition to the above drawbacks in the art, known munitions vehicles are believed to be inadequately maneuverable for their intended purpose. For example, extremely accurate positioning is required in order to situate a munition in preparation for mounting it to an aircraft. In this regard, conventional vehicles typically employed for loading munitions are of the dual-axle-type and exhibit limited maneuverability in most directions e.g. in order to turn such a vehicle, the vehicle must also be moved either in forward or reverse (or, for some turn types, in both forward and reverse). Because the inefficient maneuverability of conventional munitions vehicles slows munitions loading and unloading and/or requires considerable operator skill, it would be desirable to have a munitions vehicle which is equipped for optimized maneuverability.

As a solution to the foregoing problem, it has been discovered by Applicants that omni-directional wheels are particularly useful when employed on a munitions carrying vehicle. In this regard, during past years, a number of designs of omni-directional vehicles have been innovated. However, most omni-directional vehicle designs are similar in that they use wheels that feature a number of rollers positioned about the periphery of the wheel with the rollers permitting the wheels to support motion in directions at an angle to the wheel's plane of rotation. Omni-directional vehicles using such omni-directional wheels can move in any direction by rotating the wheels and rollers in an appropriate combination. Each omni-directional wheel's rotation is mechanically driven and servo controlled in a coordinated fashion to cause the vehicle to follow a desired path as previously disclosed by Ilon in U.S. Pat. No. 4,598,782. Three, four, or more omni-directional wheels are connected to a suitable chassis, suspension, wheel drives, and controls to form an omni-directional vehicle. Hereinafter, all uses of the words “roller” and “rollers” refer to the type of rollers used on or designed for omni-directional wheels for omni-directional vehicles.

Omni-directional wheels can be grouped into two general classifications. The first class of wheels is comprised of a rigid hub that supports a number of free spinning rollers around its periphery. The hub is rigidly coupled to an axle that, along with other omni-directional wheels and axles, supports the vehicle. The rollers are mounted at an oblique angle to the wheel's axle and are free to rotate about their own axles. Omni-directional wheel roller mounting angles of ninety degrees have been disclosed by Blumrich in U.S. Pat. No. 3,789,947. The omni-directional wheel disclosed by Blumrich was mechanically driven to produce motion parallel to the axis of rotation of the wheel. Omni-directional wheel designs with a ninety-degree roller mounting angle and free-spinning rollers have been disclosed by Bradbury in U.S. Pat. No. 4,223,753; Hiscock in U.S. Pat. No. 4,335,899; Smith in U.S. Pat. No. 4,715,460; and Guile in U.S. Pat. Nos. D318,219 and D318,791. Omni-directional wheels with rollers mounted obliquely at roller mounting angles of approximately forty-five degrees with respect to the wheel shaft have been disclosed by Ilon in U.S. Pat. No. 3,876,255 and Amico in U.S. Pat. No. 5,701,966. U.S. Pat. Nos. 3,876,255 and 5,701,966 are hereby incorporated by reference in their entirety.

The second class of omni-directional wheels differ from the above described omni-directional wheel design concepts in that the rotational axes of the free spinning rollers intersect with the wheel's axis of rotation. Wheels of this class have been disclosed by Bradbury in U.S. Pat. No. 4,223,753, and by Pin, et al, in U.S. Pat. No. 5,374,879. In wheels of this class, two or more spherical rollers are mounted in fixed positions so as to constrain the vehicle's motion in the direction of wheel rotation, while being unconstrained in a direction that is orthogonal to the wheel's axis.

In known classes of omni-directional wheels, the axle supporting each roller may be mounted to the omni-directional wheel hub at both ends of the roller, as disclosed by Blumrich, in the center, as disclosed by Ilon and Amico, or at intermediate locations, as disclosed by Smith. Typically, omni-directional wheel rollers are coated with an elastomer surface contact material to improve traction, as disclosed by Blumrich, Ilon and Smith.

Despite the known commercial need for omni-directional vehicles, initial omni-directional technologies did not achieve widespread commercial success due in part to the vibration and uneven ride produced by early omni-directional wheel designs. However, various improvements in omni-directional wheel designs have been made in recent years and are exemplified by the disclosures of U.S. Pat. Nos. 6,340,065 and 6,547,340 owned by Airtrax, Inc. In particular, the improvements in omni-directional wheel technologies that have been made by Airtrax, Inc. have vastly improved their commercial viability. Such commercial usefulness has been principally improved by designing an omni-directional wheel which exhibits constant compliance while rotating under load and which can travel substantially unencumbered over obstacles (e.g. such as a length of chain lying on a ship deck). Moreover, when such a wheel design is employed on a vehicle, the vehicle exhibits substantially constant ride height during directional operation thereby reducing vehicle vibration and allowing higher safe operational speeds. Still other improvements in omni-directional wheels made by Airtrax, Inc. have increased the load carrying capacity of the wheels which is particularly relevant to munitions handling vehicles because munition loads tend to be quite heavy.

For the foregoing reasons, Applicants herein have recognized the benefits of employing omni-directional technologies on munitions handling vehicles, and, in particular, those omni-directional technologies developed in recent years by Airtrax, Inc.

In view of the above-enumerated drawbacks, it is apparent that there exists a need in the art for apparatus and/or methods which solve and/or ameliorate at least one of the above drawbacks. It is a purpose of this invention to fulfill this need in the art, as well as other needs which will become apparent to the skilled artisan once given the following disclosure.

### SUMMARY OF INVENTION

Generally speaking, this invention fulfills the above described needs in the art by providing:

a load carrying vehicle comprising:

a vehicle frame;

wheels operationally connected to the vehicle;

a tray for carrying a cargo load, the tray being carried by a portion of the vehicle, the tray being selectively ejectable from the vehicle thereby to selectively eject cargo loads from the vehicle.

In further embodiments, this invention provides: a method of ejecting a munition from a munitions handling vehicle, the method comprising:

directing the vehicle to a ramp surface, the ramp surface having a initial width at an upper surface thereof, the ramp surface being declined towards a disposal area, and the ramp surface having a decreased width at a constriction thereof at a location located downwardly distant from the upper surface;

operating the vehicle carrying a munition to a location proximal the upper surface of the ramp such that gravity operates to locomote the vehicle downwardly on the ramp surface;

the vehicle having a plurality of wheels, each wheel having an axis of rotation;

the vehicle having a horizontal plane extending between the plurality of wheels' axes of rotation; and

the vehicle having a minimum width in the horizontal plane which is greater than the decreased width at the constriction of the ramp surface; and

wherein when the vehicle is locomoted downwardly on the ramp surface, the constriction obstructs the vehicle from travel beyond the decreased width area; and whereby thereafter the munition is ejected from the vehicle by operation of gravity thereon.

In at least one embodiment of the subject invention it is an object to provide a vehicle including an ejection actuation mechanism comprising a lever for selectively locking and unlocking the tray to the surface of the vehicle.

In an additional embodiment it is an object to provide a vehicle wherein the lever comprises: a lever arm selectively moveable between a first lock position and a second eject position; wherein, in the lock position, the lever arm secures the tray to a portion of the vehicle; and wherein, when the lever arm is actuated to the eject position, a mechanism biases the tray into a roller engaging position such that the tray is movable to eject a load therefrom.

In an additional embodiment, it an object to provide a vehicle wherein the tray is in a roller engaged position, the tray is movable on a surface of the roller such that when the vehicle is oriented at an angle greater than a threshold angle, the tray will eject from the vehicle due to gravitational forces.

In an additional embodiment it is an object to provide a vehicle wherein the vehicle includes a vehicle axis extending between a front and a rear portion of the vehicle; wherein, when the tray ejects from the vehicle, the tray ejects in a direction initially substantially in line with the vehicle axis.

In an additional embodiment, it is an object of the invention to provide a vehicle wherein when the lever arm is moved from the lock position to the eject position, a mechanism advances the tray a distance from the cargo carrying position into a eject position.

In an additional embodiment, it is an object of the invention to provide a vehicle, wherein when the tray is advanced the distance into the eject position, a surface of the tray is engaged to at least one roller such that the tray is movable along a surface via the roller thereby to eject a cargo load from the vehicle.

In yet a further embodiment, it is an object of the invention to provide a vehicle, wherein the vehicle is so designed such that cargo loads are ejected from the vehicle by ejecting the tray from the vehicle.

In still further embodiments, it is an object of the invention to provide a vehicle wherein the tray mount comprises a pair of tray mount rails located on a surface of the vehicle, the tray mount rails including a guide structure capable of guiding the tray as the tray is ejected from the vehicle.

In an even further embodiment, it is an object of the invention to provide a vehicle wherein the vehicle is motorized and the wheels of the vehicle enable omni-directional operation of the vehicle.

In an additional embodiment it is an object of the invention to provide a vehicle which further comprises:

at least one mount roller rotatably connected to the tray mount, the mount roller being so located on the tray mount such that the mount roller engages the tray when the lever arm is in the eject position; and

at least one tray roller rotatably connected to the tray, the tray roller being so located on the tray such that the tray roller engages the tray mount when the lever arm is in the eject position.

In an additional embodiment it is an object of the invention to provide a vehicle wherein the tray mount includes a mount rolling surface to which say tray roller is selectively engageable; and

wherein the tray includes a tray rolling surface to which the mount roller is selectively engageable.

In an additional embodiment, it is an object of the invention to provide a munitions carrying vehicle wherein the vehicle further includes:

a tray rolling surface located on a downward facing side of the tray;

a mount rolling surface located on an upward facing side of the tray mount; and

the mount roller being located proximal the front of the vehicle; and

wherein when the lever arm is located in the lock position, the mount roller is disengaged with the tray rolling surface and is located substantially forward of the tray, and the tray roller is disengaged from the mount rolling surface and is located substantially rearward of the mount rolling surface.

In still further embodiments, it is an object of the invention to provide a vehicle wherein the controller is connected to the vehicle with an operator boom structure comprising:

a first, a second, and a third arm;

the first arm connected to the vehicle via a first linkage, and the first arm connected between the first linkage and a second linkage;

the second arm connected between the second linkage and a third linkage; and

the third arm connected between the third linkage and the controller;

wherein the operator boom structure is so designed and so connected between the vehicle and the controller such that the operator boom structure enables a selected angular orientation of the controller to be maintained with respect to an angular orientation of the vehicle.

### BRIEF DESCRIPTION OF THE DRAWINGS

FIG. 1. illustrates a profile view of a load carrying vehicle according to one embodiment of the subject invention illustrated employing self-driven omni-directional wheel modules for optimizing vehicle maneuverability.

FIG. 2. illustrates the embodiment of the load carrying vehicle depicted in FIG. 1 shown with the load carrying mechanism in an eject position.

FIG. 3. illustrates a three-dimensional view of the load carrying vehicle illustrated in FIG. 2.

FIG. 4 illustrates an overhead detailed view of a load carrying and ejecting mechanism, including lock/unlock mechanisms shown in both locked and unlocked positions, respectively, according to one embodiment of the subject invention.

FIG. 5 illustrates a profile view of the load carrying and ejecting mechanism depicted in FIG. 4 with the lock/unlock mechanism shown in a locked position.

FIG. 6 illustrates overhead, side-profile, and front-profile views of a tray carriage device according to one embodiment of a load carrying and ejecting mechanism according to the subject invention.

FIG. 7A illustrates an overhead view of a load carrying and ejecting mechanism according to one embodiment of the subject invention including a load carrying tray and tray carriage device as depicted in FIG. 6.

FIG. 7B illustrates a profile view of the load carrying and ejecting mechanism depicted in FIG. 7A with the load carrying tray shown in an alternate carrying position and eject position by solid and dotted lines, respectively.

FIG. 8 illustrates an exemplar range of motion of one embodiment of an operator station according to the subject invention.

### DETAILED DESCRIPTION OF CERTAIN EMBODIMENTS

For a more complete understanding of the present invention and advantages thereof, reference is now made to the following description of various illustrative and non-limiting embodiments thereof, taken in conjunction with the accompanying drawings in which like reference numbers indicate like features.

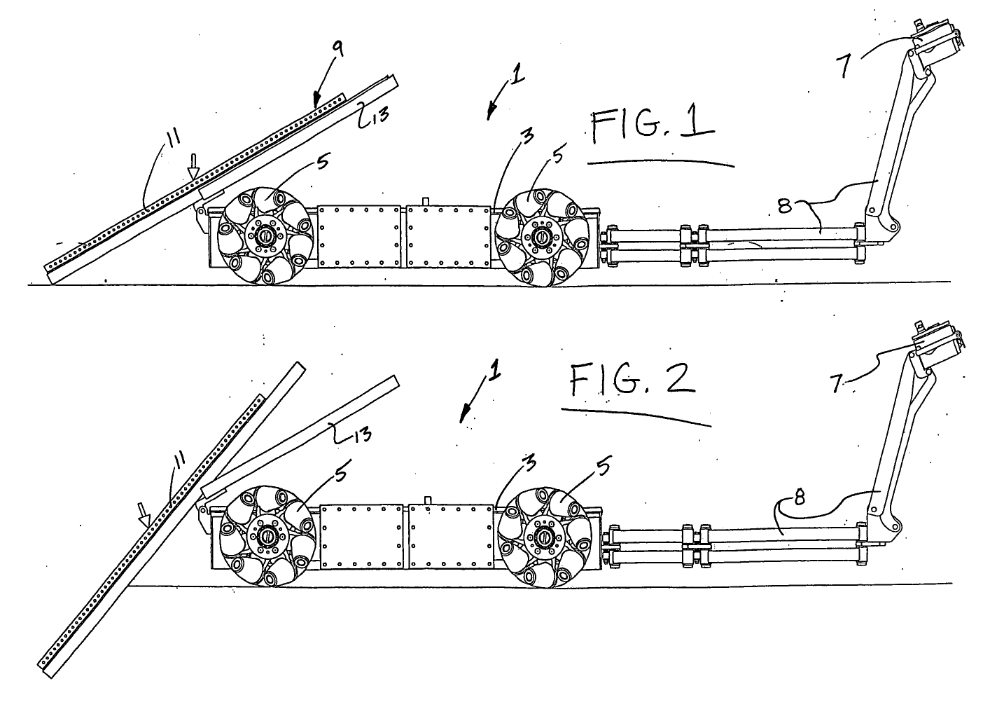

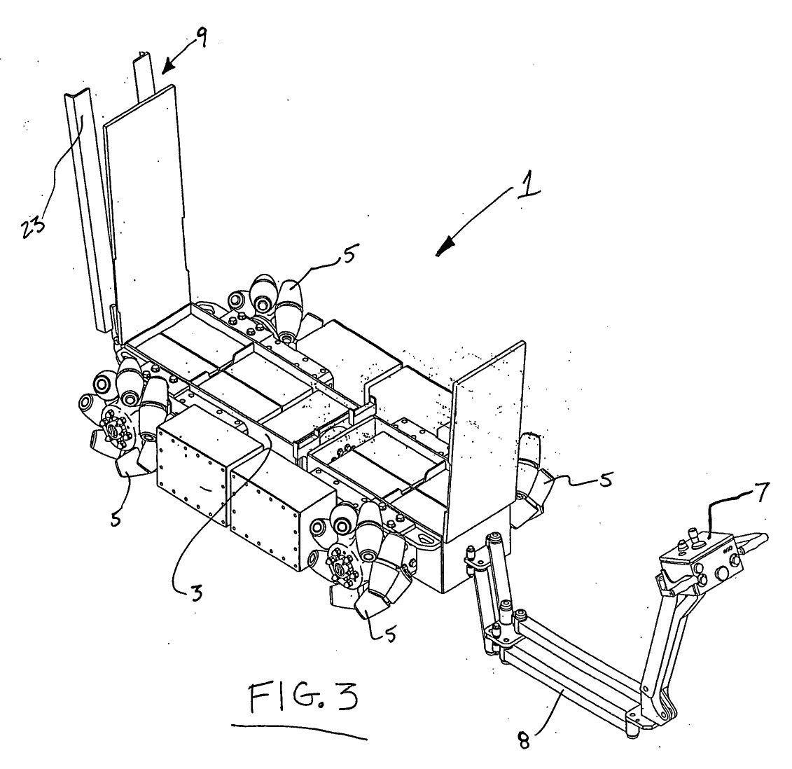

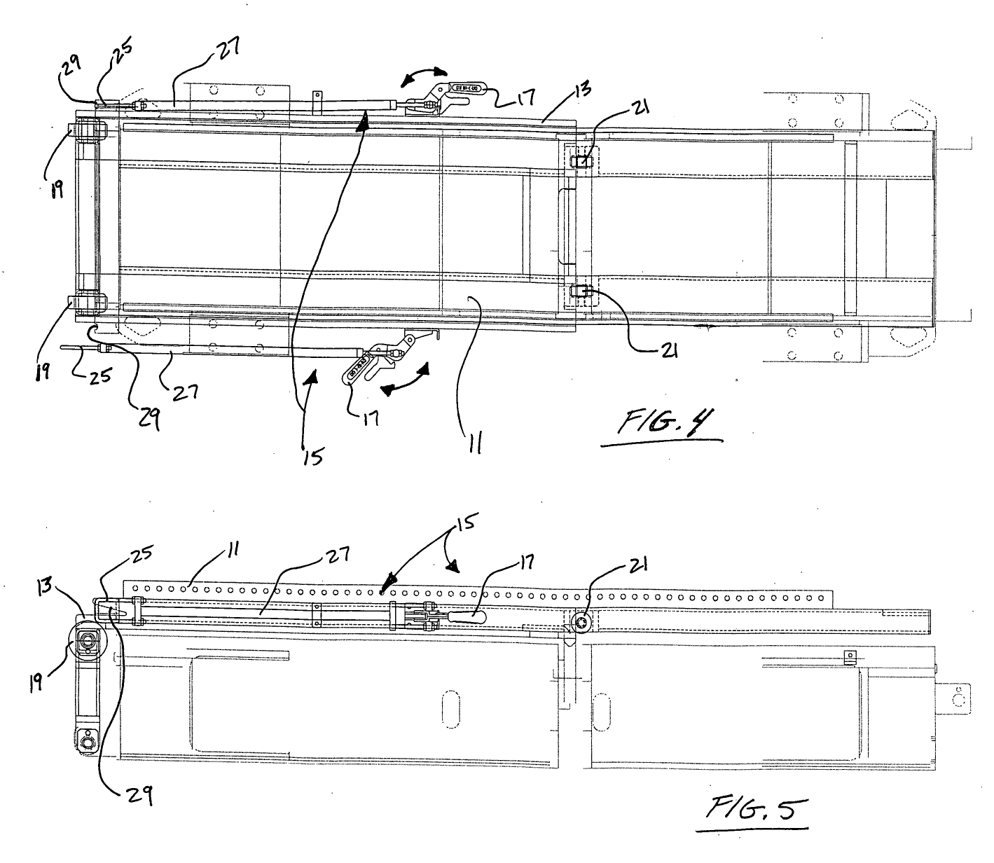

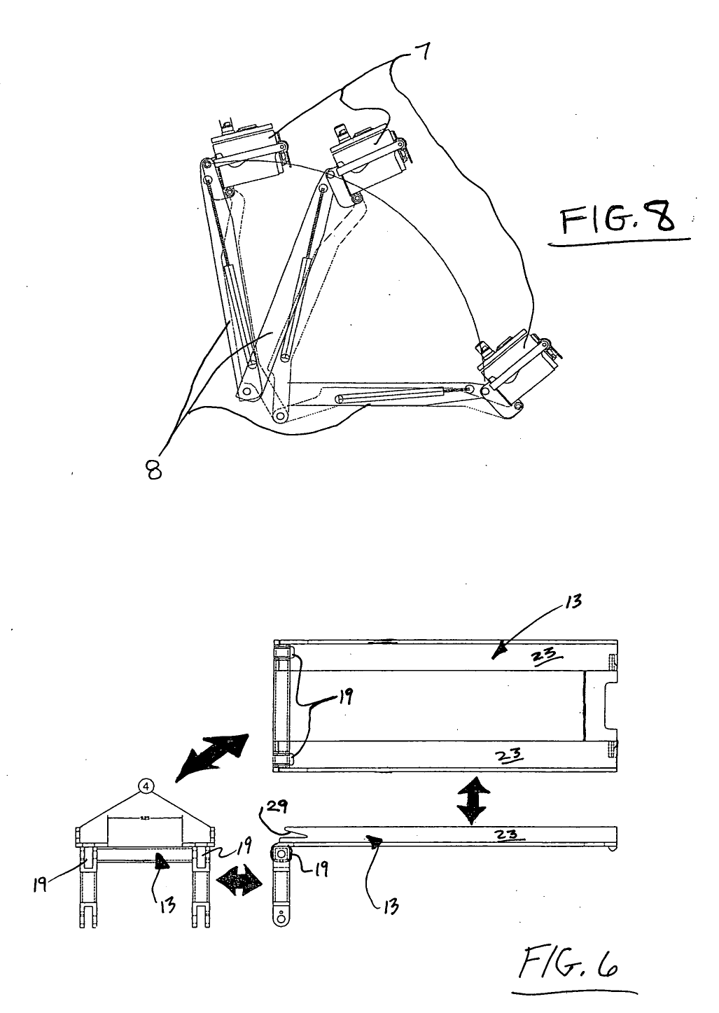

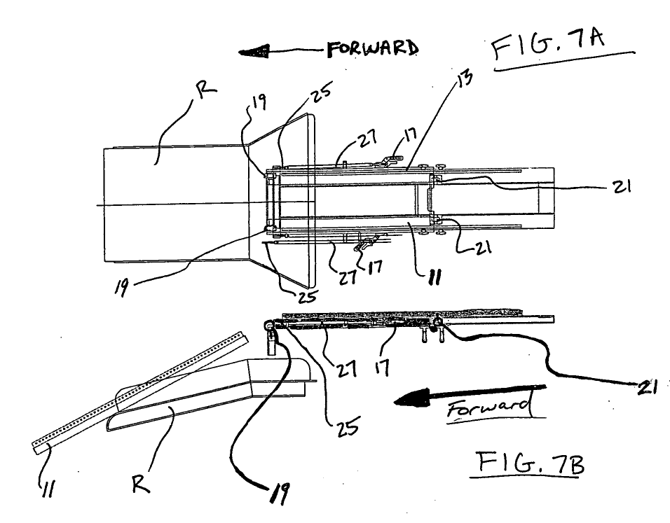

Referring initially to FIGS. 1, 2, and 3, therein is illustrated a vehicle 1 embodying one example of a load carrying transportation vehicle according to the subject invention (e.g., having a unique load ejection mechanism such as described in detail below). Although vehicle 1 may be employed in the illustrated configuration or in alternative configurations to carry a wide variety of load types, the vehicle depicted is particularly suited for the transportation of munition loads and will thus be principally discussed with regards to its use for such purpose.

In the embodiment which is illustrated, vehicle 1 generally comprises a chassis 3 to which a plurality of omni-directional wheels 5 are assembled for providing directional motion to the vehicle as well as a load carrying platform 9 for carrying munitions (or other load types, for example). In order so that the vehicle can be operated, the vehicle further includes an operator interface 7 for controlling the directional motion of the vehicle (i.e., connected to the vehicle chassis via boom 8). As can be seen in FIGS. 1 and 2, load carrying platform 9 is pivotally connected to the chassis of vehicle 1 so that the platform can be angled to and from its normally horizontal position to effect the discharge of a load when desired. For example, in order to eject a vehicle load, the platform is caused to articulate to or beyond a threshold angle as is approximated in the illustration of FIG. 2. When platform 9 is angled at or beyond its threshold angle in such an embodiment, tray 11 ejects from its tray mount 13 by operation of gravity (e.g., in some embodiments, the ejection maneuver is assisted or actuated by additional mechanical forces).

Although, in preferred embodiments, the wheels employed on vehicle 1 are of an omni-directional type, and in most preferred embodiments, are of a type manufactured by Airtrax, Inc. (under various U.S. patents such as discussed in the BACKGROUND section above), certain embodiments are contemplated in which conventional, non-omni-directional wheels, or, omni-directional wheels which are not manufactured by Airtrax, Inc., are employed.

Referring now to FIGS. 4, 5, and 6, a detailed view of an exemplar ejection actuation mechanism 15 is depicted therein. As is illustrated in the figures, ejection mechanism 15 is generally comprised of a combination of components designed and configured for alternately securing a load to transportation vehicle 1 (carried and/or attached to tray 11) and either unloading the cargo in a non-emergency operation or ejecting dangerous cargo, such as hot munitions, in more urgent operations such as when a munition being carried is determined to be defective (e.g., by ejecting tray 11). More specifically, in the embodiment illustrated, ejection mechanism 15 includes tray 11 for carrying vehicle loads, tray mount 13 for carrying tray 11 and a locking and ejection mechanism for locking and unlocking tray 11 to the tray mount and for ejecting tray 11 when load ejection is desired.

The locking mechanism shown in FIGS. 4 and 5 generally includes a lever 17 which operates a latching mechanism 25 via its connection thereto by linkage arm 27. In its most basic form, lever 17 can be operated to lock or unlock tray 13 to the tray mount by engaging or disengaging latching mechanism 25 to and from catch 29. In preferred embodiments, however, additional functions and/or structures which aid in the ejection of tray 11 from the vehicle are utilized. Specifically, and still referring to FIGS. 4 and 5, in preferred embodiments, mount 13 has, operatively connected thereto, a mount roller 19 and tray 11 includes a tray roller 21. When tray 11 is in the locked condition (and lever 17 is in a locked orientation with latching mechanism 25 in engagement with catch 29), roller 19 is located forward of tray 11 and the tray is in static, surface to surface contact with the tray mount (e.g., via metal to metal contact). Moreover, roller 21 is located rearward of the horizontal planar surface of the tray mount. Thus, when tray 11 is in such a locked position, the non-engagement of the rollers to respective rolling surfaces (in combination with the locking operation of latching mechanism 25) reliably secures tray 11, and thus its load, to vehicle 1. Conversely, when lever 17 is operated to an unlocked or open position, the action and configuration of the lever, in some embodiments, advances tray 11 a sufficient distance forward to engage rollers 19 and 21 to their respective rolling or traveling surfaces. Thus, because the tray is no longer secured to the tray mount via the latch and catch arrangement, and because the tray is now resting on a rolling (or similar low friction) surface, tray 11 can be ejected by simple operation of gravity (when the load carrying platform is articulated or otherwise angled for ejection, for example). It is reminded, in this regard, that tray mount 13 is pivotably connected to the vehicle chassis to allow for and/or effect such load ejection maneuvers.

As can be seen most clearly in the example depicted in FIGS. 3 and 6, tray mount 13, in preferred embodiments, is comprised of a pair of mount rails 23 connected to a vertical member carrying mount roller 19 and provided for additionally connecting the tray mount pivotably to the vehicle chassis. In such preferred embodiments, tray 11 is sized and configured so that when it is mounted to the vehicle, the tray nests between the vertical sides of rails 23. Moreover, during ejection operations, the mount rails serve to guide the tray in an initial, generally linear trajectory as it is ejected from the vehicle (e.g, onto ramp R located on an aircraft carrier, see FIGS. 7A and 7B). Moreover, as discussed briefly above, the horizontal surfaces of the L-shaped rails serve as the rolling or traveling surface for tray rollers 21 during ejection operations.

Turning now briefly to FIG. 8 and referring again to FIG. 3, an example of an operator interface 7 and its associated connecting arm or boom 8 is illustrated therein. These figures, in particular, depict various ranges of motion which are achievable using such an operator interface and boom combination which are useful when maneuvering vehicle 1 in tight spaces, for example (e.g., under aircraft underbodies). Nevertheless, other user interface or vehicle control mechanisms, including remote control mechanisms, are contemplated as within the scope of the invention.

Once given the above disclosure, many other features, modifications, and improvements will become apparent to the skilled artisan. Such other features, modifications, and improvements are therefore considered to be part of this invention, the scope of which is to be determined by the following claims:

We claim:

1. A load carrying vehicle comprising:
a vehicle frame;
wheels operationally connected to said vehicle;
a tray for carrying a cargo load, said tray being carried by a portion of said vehicle, said tray being selectively ejectable from said vehicle thereby to selectively eject cargo loads from said vehicle.

2. A vehicle according to claim 1 wherein said vehicle further includes an ejection actuation mechanism, said ejection actuation mechanism comprising:
a lever for selectively locking and unlocking said tray to a surface of said vehicle;
said lever permitting a cargo load to be ejected when said lever is in said unlocked position.

3. A vehicle according to claim 2 wherein said lever comprises:
a lever arm selectively moveable between a first lock position and a second eject position;
wherein, in said lock position, said lever arm secures said tray to a portion of said vehicle; and
wherein, when said lever arm is actuated to said eject position, a mechanism biases said tray into a roller engaging position such that said tray is movable to eject a load therefrom.

4. A vehicle according to claim 3 wherein when said tray is in a roller engaged position, said tray is movable on a surface of said roller such that when said vehicle is oriented at an angle greater than a threshold angle, said tray will eject from said vehicle due to gravitational forces.

5. A vehicle according to claim 4 wherein said vehicle includes a vehicle axis extending between a front and a rear portion of said vehicle;
wherein, when said tray ejects from said vehicle, said tray ejects in a direction initially substantially in line with said vehicle axis.

6. A vehicle according to any one of the preceding or following claims, or any combination thereof, further comprising:
a tray mount connected to said vehicle, said tray located in contact with a tray engaging surface of said tray mount.

7. A vehicle according to any one of the preceding or following claims, or any combination thereof, wherein when said lever arm is oriented in said lock position, said tray is locked substantially immovably to said tray mount; and
wherein when said lever arm is oriented in said eject position, said tray is unlocked from said tray mount and is slidably movable on a surface thereof.

8. A vehicle according to any one of the preceding or following claims, or any combination thereof, wherein when said tray is locked to said tray mount, said tray is located in a cargo carrying position; and
wherein when said lever arm is moved from said lock position to said eject position, a mechanism advances said tray a distance from said cargo carrying position into a eject position.

9. A vehicle according to any one of the preceding or following claims, or any combination thereof, wherein when said tray is advanced said distance into said eject position, a surface of said tray is engaged to at least one roller such that said tray is movable along a surface via said roller thereby to eject a cargo load from said vehicle.

10. A vehicle according to any one of the preceding or following claims, or any combination thereof, wherein said vehicle is so designed such that cargo loads are ejected from said vehicle by ejecting said tray from said vehicle.

11. A vehicle according to any one of the preceding or following claims, or any combination thereof, wherein said tray mount comprises a pair of tray mount rails located on a surface of said vehicle, said tray mount rails including a guide structure capable of guiding said tray as said tray is ejected from said vehicle.

12. A vehicle according to any one of the preceding or following claims, or any combination thereof, wherein said tray mount is pivotally connected to said vehicle.

13. A vehicle according to any one of the preceding or following claims, or any combination thereof, wherein said tray mount is pivotally connected to said vehicle proximal one end of said tray mount such that said tray mount is tiltable with respect to said vehicle frame.

14. A vehicle according to any one of the preceding or following claims, or any combination thereof, wherein said tray mount is pivotally connected proximal one end of said vehicle.

15. A vehicle according to any one of the preceding or following claims, or any combination thereof, wherein said tray mount is tiltable substantially in said axis of said vehicle thereby to eject said tray from said tray mount.

16. A vehicle according to any one of the preceding or following claims, or any combination thereof, wherein said vehicle is motorized and said wheels of said vehicle enable omni-directional operation of said vehicle.

17. A vehicle according to any one of the preceding or following claims, or any combination thereof, wherein said vehicle further comprises:
a roller rotatably connected to said tray such that said tray can be advanced linearly along a surface of said vehicle thereby to eject a cargo load.

18. A vehicle according to any one of the preceding or following claims, or any combination thereof, wherein said vehicle further comprises:
a roller rotatably connected to said tray mount such that said tray can be advanced linearly along said roller thereby to eject a cargo load.

19. A vehicle according to one of claims 6-18 wherein said vehicle further comprises:
at least one mount roller rotatably connected to said tray mount, said mount roller being so located on said tray mount such that said mount roller engages said tray when said lever arm is in said eject position; and
at least one tray roller rotatably connected to said tray, said tray roller being so located on said tray such that said tray roller engages said tray mount when said lever arm is in said eject position.

20. A vehicle according to claim 19 wherein said tray mount includes a mount rolling surface to which say tray roller is selectively engageable; and
wherein said tray includes a tray rolling surface to which said mount roller is selectively engageable.

21. A vehicle according to claim 19 wherein said vehicle further includes:
a tray rolling surface located on a downward facing side of said tray;
a mount rolling surface located on an upward facing side of said tray mount; and
said mount roller being located proximal said front of said vehicle; and
wherein when said lever arm is located in said lock position, said mount roller is disengaged with said tray rolling surface and is located substantially forward of said tray, and said tray roller is disengaged from said mount rolling surface and is located substantially rearward of said mount rolling surface.

22. A vehicle according to claim 20 or 21 wherein when said lever arm is actuated to said eject position, said tray is biased in a forward direction along said vehicle axis and said mount roller engages said tray rolling surface and said tray roller engages said mount rolling surface.

23. A vehicle according to any one of the preceding or following claims, or any combination thereof, further including a re-locatable operator station for directionally operating said vehicle, said re-locatable operator station comprising:
a controller for controlling directional operation and positioning of said vehicle, said controller being movable in positional orientation with respect to said vehicle, said controller being so designed and connected to said vehicle such that a desired angular orientation of said controller with respect to said axis of said vehicle is capable of being selectively maintained.

24. A vehicle according to any one of the preceding or following claims, or any combination thereof, wherein said controller is connected to said vehicle via a linkage, said linkage permitting lateral movement of said controller with respect to said vehicle.

25. A vehicle according to any one of the preceding or following claims, or any combination thereof, wherein said controller is connected to said vehicle via a linkage, said linkage permitting vertical movement of said controller with respect to said vehicle.

26. A vehicle according to any one of the preceding or following claims, or any combination thereof, wherein said controller is connected to said vehicle with an operator boom structure comprising:
a first, a second, and a third arm;
said first arm connected to said vehicle via a first linkage, and said first arm connected between said first linkage and a second linkage;
said second arm connected between said second linkage and a third linkage; and
said third arm connected between said third linkage and said controller;
wherein said operator boom structure is so designed and so connected between said vehicle and said controller such that said operator boom structure enables a selected angular orientation of said controller to be maintained with respect to an angular orientation of said vehicle.

27. A vehicle according to any one of the preceding or following claims, or any combination thereof, wherein said wheels of said vehicle are so constructed such that a vehicle employing a plurality of such wheels exhibits substantially constant ride height during omni-directional operation.

28. A vehicle according to any one of the preceding or following claims, or any combination thereof, wherein each wheel of said vehicle comprises:
a hub;
a plurality of roller mounting brackets coupled to said hub; and
a plurality of rollers each rotatably coupled to at least one of said roller mounting brackets at a roller mounting angle substantially between 20 and 90 degrees, said rollers comprising;
a core rotatably coupled to said roller mounting bracket, said core having a first end and a second end; and
a contact surface of elastomeric material coupled to and radially disposed about said core with a volumetric shape such that the exterior profile of said contact surfaces of all said rollers forms a noncircular profile when viewed from a perspective laterally displaced from and coincident with the centerline of said hub.

29. A vehicle according to any one of the preceding or following claims, or any combination thereof, wherein said contact surface of said rollers is disposed about said core with a radial diameter near said first end of said core that exceeds the radial diameter that would result in a circular profile when viewed from a perspective laterally displaced from and coincident with the centerline of said hub.

30. A vehicle according to any one of the preceding or following claims, or any combination thereof, wherein said rollers are further comprised of: a roller segment, wherein said contact surface of said roller segment is disposed about said core with a radial diameter near an end of said roller segment that exceeds the radial diameter that would result in a circular profile when viewed from a perspective laterally displaced from and coincident with the centerline of said hub.

32. A vehicle according to any one of the preceding or following claims, or any combination thereof, wherein said contact surface of said rollers further comprises:
a first zone of elastomeric material disposed about said core, said first zone positioned between said first and second ends of said core; and
a second zone of elastomeric material disposed about said core, said second zone positioned between said first zone and said first end of said core and having a material stiffness that is different from the material stiffness of said first zone.

33. A vehicle according to any one of the preceding or following claims, or any combination thereof, wherein said controller is a walk-behind controller.

34. A vehicle according to any one of the preceding or following claims, or any combination thereof, wherein said controller is a remotely controlled controller.

35. A vehicle according to any one of the preceding or following claims, or any combination thereof, wherein said controller communicates with said vehicle wirelessly.

36. A vehicle according to any one of the preceding or following claims, or any combination thereof, wherein said vehicle tray is configured to carry munitions.

37. A vehicle according to any one of the preceding or following claims, or any combination thereof, wherein munitions are capable of being secured to said tray such that munitions are selectively immovable with respect to said vehicle when said lever arm is in said lock position.

38. A method of ejecting a munition from a munitions handling vehicle, said method comprising:
directing said vehicle to a ramp surface, said ramp surface having a initial width at an upper surface thereof, said ramp surface being declined towards a disposal area, and said ramp surface having a decreased width at a constriction thereof at a location located downwardly distant from said upper surface;
operating said vehicle carrying a munition to a location proximal said upper surface of said ramp such that gravity operates to locomote said vehicle downwardly on said ramp surface;
said vehicle having a plurality of wheels, each wheel having an axis of rotation;
said vehicle having a horizontal plane extending between said plurality of wheels' axes of rotation; and
said vehicle having a minimum width in said horizontal plane which is greater than said decreased width at said constriction of said ramp surface; and
wherein when said vehicle is locomoted downwardly on said ramp surface, said constriction obstructs said vehicle from travel beyond said decreased width area; and whereby thereafter said munition is ejected from said vehicle by operation of gravity thereon.

39. The method according to claim 38 wherein said vehicle comprises:
a vehicle according to one of claims 2-37; and
said method further comprising the method step of:
actuating said lever to an unlocked position such that said tray is unlocked from said surface of said vehicle prior to releasing said vehicle for travel downwardly on said ramp surface.

40. The method according to claim 38 wherein said vehicle comprises:
a vehicle according to one of claims 2-37; and
said method further comprising the step of:
actuating said lever to an unlocked position such that said tray is unlocked from said surface of said vehicle, and advancing said tray to a roller engaging position prior to releasing said vehicle for travel downwardly on said ramp surface.

41. The method according to claim 39 or 40 wherein when said vehicle contacts said constriction during downward travel on said ramp surface, said tray travels along a surface of said roller and ejects from said vehicle downwardly towards said disposal area.
